(19) United States
(12) Patent Application Publication
(10) Pub. No.: US 2022/0126520 A1
(43) Pub. Date: Apr. 28, 2022

(54) Three-Dimensional Printing System with Improved Motion and Imaging Control

(71) Applicant: 3D Systems, Inc., Rock Hill, SC (US)

(72) Inventor: Peter Scott Turner, Venice, CA (US)

(21) Appl. No.: 17/499,329

(22) Filed: Oct. 12, 2021

Related U.S. Application Data
(60) Provisional application No. 63/105,951, filed on Oct. 27, 2020.

(51) Int. Cl. B29C 64/393; B29C 64/124; B29C 64/245; B33Y 10/00; B33Y 30/00; B33Y 50/02

(52) U.S. Cl. CPC B29C 64/393; B29C 64/124; B33Y 50/02; B33Y 10/00; B33Y 30/00; B29C 64/245

(57) ABSTRACT

A three-dimensional printing system includes a resin vessel, a build tray, a movement mechanism, a sensor, a light engine, and a controller. The resin vessel is configured to contain photocurable (radiation curable) resin and includes a transparent sheet. The transparent sheet has an upper surface that defines a lower bound for the photocurable resin. The build tray has a lower surface configured to support the 3D article. A lower face is defined by either the build tray or the 3D article. The sensor is configured to output a signal indicative of a vertical position of the transparent sheet. The light engine is configured to image a build plane that is proximate to the upper surface of the transparent sheet. The controller is configured to control motion of the movement mechanism based upon analyzing a signal from the sensor including determining a maximum deflection of the transparent sheet during motion.

This non-provisional patent application claims priority to U.S. Provisional Application Ser. No. 63/105,951, Entitled “Three-Dimensional Printing System with Improved Motion and Imaging Control” by Scott Turner, filed on Oct. 27, 2020, incorporated herein by reference under the benefit of U.S.C. 119(e).

### FIELD OF THE INVENTION

The present disclosure concerns an apparatus and method for fabrication of solid three dimensional (3D) articles of manufacture from energy curable materials. More particularly, the present disclosure concerns a way of optimizing the speed and output quality of a three dimensional (3D) printer that utilizes resins having radiation cure components.

### BACKGROUND

Three dimensional (3D) printers are in rapidly increasing use. One class of 3D printers includes stereolithography printers having a general principle of operation including the selective curing and hardening of radiation curable (i.e., photocurable) liquid resins. One type of stereolithography system includes a containment vessel holding the curable resin, a movement mechanism coupled to a support tray, and a light engine. The stereolithography system forms a three dimensional (3D) article of manufacture by selectively curing layers of the photocurable resin onto a lower surface of the support tray. One challenge with such systems is replenishment of uncured resin at the lower surface of the support tray. Another challenge is a “settling time” for the system after resin replenishment. Resin replenishment and settling time add a large temporal burden on to a 3D print process, sometimes consuming half of the entire time required to fabricate a 3D article.

### BRIEF DESCRIPTION OF THE FIGURES

FIG. 1 is schematic diagram of an embodiment of a three-dimensional (3D) printing system.

FIG. 2 is a schematic diagram representing a build plane.

FIG. 3 is a simplified electrical block diagram of an embodiment of a controller coupled to a light engine.

FIG. 4 is a graph depicting a temporal sequence of bit planes that are sent to a pixel or individual mirror of a digital mirror device (DMD).

FIG. 5 is a flowchart depicting an embodiment of a method of manufacturing a 3D article.

FIG. 6A is a simplified side cross-sectional view of a build tray supporting a 3D article having a lower face at a build plane during selective curing of resin onto the lower face.

FIG. 6B is similar to FIG. 6A except that imaging has stopped and the build tray and 3D article have been raised up until a transparent sheet has reached a maximum deflection FZ.

### SUMMARY

In a first aspect of the disclosure, a three-dimensional printing system includes a resin vessel, a build tray, a movement mechanism, a sensor, a light engine, and a controller. The resin vessel is configured to contain photocurable (radiation curable) resin and includes a transparent sheet. The transparent sheet has an upper surface that defines a lower bound for the photocurable resin. The build tray has a lower surface configured to support the 3D article. A lower face is a downward facing surface of either the build tray or the 3D article. The sensor is configured to output a signal indicative of a vertical position of the transparent sheet. More particularly, the sensor is configured to output a signal equal to a deflected vertical distance (dZ) which is a maximum vertical deflection of the transparent sheet over lateral axes X and Y. The light engine is configured to image a build plane that is proximate to the upper surface of the transparent sheet.

The controller is configured to: (a) operate the movement mechanism to position the lower face at the build plane, (b) operate the light engine to selectively harden a layer of the photocurable resin onto the lower face, (c) operate the movement mechanism to begin raising the lower face at a specified velocity, (d) concurrent with (c), receive the signal to monitor the vertical position of the transparent sheet or dZ, (e) determine when the transparent sheet has reached a maximum upward vertical deflection (FZ), (f) determine a magnitude of the maximum upward vertical deflection (FZ), (g) based upon reaching the maximum vertical deflection (FZ), lower the lower face by a vertical distance based upon a magnitude of the maximum upward vertical deflection (FZ), (h) repeat step (b), and continue monitoring the signal and operating the movement mechanism and light engine to complete fabrication of the 3D article.

This has an advantage of reducing or eliminating settling time. By monitoring the position of the transparent sheet, the controller can halt motion when a maximum deflection (FZ) is reached. Then the controller can immediately lower the lower face back down to the build plane and operate the light engine with minimal or no settling time. The settling times in prior methods of operation would often utilize up to 50% of the total time required for fabrication of a 3D article. Stated another way, largely eliminating the settling time can double the speed of a 3D printing system with no sacrifice in quality.

In one implementation, the controller determines and computes the specified velocity of step (c) based upon a property associated with the photocurable resin in the uncured and/or cured state. The property can include a mechanical property of a cured or hardened state of the photocurable resin. The mechanical property can include one or more of elastic modulus, yield strength, or one or more other measurable quantities. The property can also be based upon a signal that is indicative of a viscous force being exerted on the lower face by the transparent sheet and/or based upon rheological properties of the photocurable resin in an uncured state. With this determination, the maximum velocity can be used without comprising or damaging the 3D article. This is assured by keeping a viscous force on the lower face of the 3D article below a yield strength of the cured resin.

In another implementation, the controller is configured to halt vertical upward motion of the build tray at the moment or time that the transparent sheet has reached a maximum upward deflection. The closer to temporal coincidence of the maximum upward deflection (FZ) and halting motion, the less settling time will be required between steps.

In yet another implementation, the light engine is activated in step (h) in less than 500 milliseconds after vertical motion in step (g) has stopped. More particularly, the light engine is activated in step (h) in less than 200 milliseconds after vertical motion in step (g) has stopped. Yet more particularly, the light engine is activated in step (h) in less than 100 milliseconds after vertical motion in step (g) has stopped. The reduction or elimination of settling time has a dramatic effect on the total operational cycle time.

In a further implementation, the light engine includes a light source and a spatial light modulator. A vertical position (LZ) of the build tray correlates with an encoder signal from the movement mechanism. The controller stores a plurality of image frames that define slices of the 3D article. The plurality of image frames are stored with associated values of LZ. Based on an encoder signal from the movement mechanism, the controller loads the associated image frame into the spatial light modulator. Thus, spatial modulation of light from the light source is controlled by the reading of the encoder signal. On the other hand, the light source is activated or turned ON by activation or turning ON of the light source. The light source is turned on at the beginning of step (b) and turned off at the end of step (b) while the appropriate image frame is loaded into the spatial light modulator.

The spatial light modulator can include a digital mirror device (DMD) formatter and a DMD. The DMD formatter converts an incoming image frame that is an array of dosage values into an array of binary numbers corresponding to bit planes. The DMD formatter then sequentially sends the bit planes to the DMD so that mirror elements of the DMD are either ON or OFF during bit plane time slices.

### DETAILED DESCRIPTION OF THE PREFERRED EMBODIMENTS

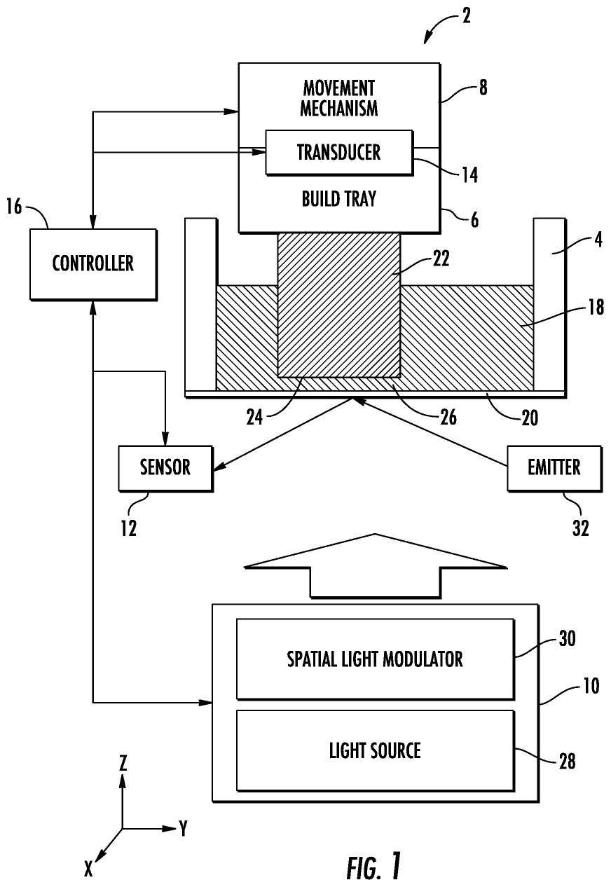

FIG. 1 is a schematic diagram of an embodiment of a three-dimensional (3D) printing system 2 including a resin vessel 4, a build tray 6, a movement mechanism 8, a light engine 10, a sensor 12, a transducer 14, and a controller 16. The controller 16 is electrically or wirelessly coupled to the movement mechanism 8, the light engine 10, the sensor 12, the transducer 14, and other components of 3D printing system 2 not illustrated for simplicity.

In describing the 3D printing system 2, mutually orthogonal axes X, Y, and Z are used. Axes X and Y are lateral axes that are generally horizontal. The Z axis is generally vertical or generally aligned with a gravitational reference. When the term “generally” is used, it indicates that a direction or magnitude may not be exact but is within manufacturing tolerances. Thus, generally aligned indicates aligned to within manufacturing tolerances.

The resin vessel 4 contains a photocurable (radiation curable) resin 18. The resin vessel 4 includes a transparent sheet 20 that defines a lower bound for the photocurable resin 18. The photocurable resin 18 is a liquid resin and is photocurable in the sense that it is radiation curable with blue, violet, and/or ultraviolet (UV) radiation. In some embodiments, the photocurable resin 18 can also contain other components that are curable with thermal energy or infrared radiation. The transparent sheet 20 is semipermeable to oxygen, which acts as an inhibitor to radiation curing of the photocurable resin 18 at an interface between the photocurable resin 18 and the transparent sheet 20.

The build tray 6 has a lower surface or face for supporting a 3D article 22 being fabricated or manufactured by the 3D printing system 2. From here forward, a lower face 24 is a lower face 24 of the build tray 6 or the article 22 being fabricated.

The build tray 6 is coupled to a movement mechanism 8. The movement mechanism 8 is a motorized device for vertically positioning the build tray 6 and outputting an encoder signal that is indicative of a vertical position of the build tray 6. In an illustrative embodiment, the movement mechanism 8 includes a vertically fixed portion and a vertically moving portion. The vertically moving portion supports the build tray and includes a threaded bearing. The vertically fixed portion includes a motor coupled to a lead screw which is received within the threaded bearing. As the motor rotates the lead screw, the action upon the threaded bearing translates the build tray up or down, depending upon the rotational direction of the lead screw. The encoder can be a linear or rotational encoder and outputs a signal by which the controller can determine and monitor a vertical position of the build tray 6 and hence by inference the lower face 24. In the discussion follows, a variable LZ will be considered a linear vertical coordinate that relates to the vertical position of the build tray 6.

The light engine 10 is configured to project or transmit radiation to a build plane 26 that is above but proximate to the transparent sheet 20. The build plane 26 is defined by a fixed vertical height above the transparent sheet 20 and has lateral limits that are lateral limits of the light engine 10. In the illustrated embodiment, the light engine 10 includes a light source 28 and a spatial light modulator 30. In another embodiment, the light engine 10 can be a light bar with an array of light emitting devices (LEDs). Other designs of the light engine are possible that include one or more of light sources, spatial light modulators, LEDs, and lasers.

In the illustrated embodiment, the sensor 12 is configured to sense a vertical (Z) position of the transparent sheet 20. In an illustrative embodiment, the sensor 12 is part of an emitter/detector pair including emitter 32. In some embodiments, emitter 32 can include a plurality of emitters 32 that impinge upon the transparent sheet 20 at different locations. The sensor 12 outputs a signal to controller 16 that is indicative of a vertical position of a portion of the transparent sheet 20. Generally speaking a deflected vertical distance (dZ) is equal to a maximum vertical deflection of the transparent sheet over X and Y from an initial or planar state. The sensor 12 outputs a signal indicative of dZ.

The transducer 14 is configured to output a signal that is at least partially indicative of a static and/or dynamic force being exerted on the build tray 6. In one embodiment, the transducer 14 is a load cell. The signal can be indicative of viscous forces of motion of the lower face 24 being moved within the photocurable resin 18 and particularly when the lower face 24 is proximate to the transparent sheet 20. Thus, the signal can be indicative of certain rheological properties of the photocurable resin 18. In some embodiments, the controller 16 is configured to process the signal from transducer 14. This can include subtracting a dynamic signal (during motion) from a static signal.

The controller 16 includes a non-transient storage device coupled to a processor. The non-transient storage device stores software instructions. When executed by the processor, the software instructions perform operations that the controller 16 is configured to perform. Some of these operations are listed as follows: (A) Receive the signal from transducer 14 and then determine a rheological property of the photocurable resin. (B) Receive an input indicative of a material property of cured resin that is a result of curing the photocurable resin. The material property can be one or more of an elastic modulus, a yield strength, or another physical property. (C) Process information indicative of a rheological property of the resin and a material property of the cured resin to determine a specified velocity for operating the movement mechanism 8 and vertically moving the build tray 6—particularly when the lower face 24 is proximate to the transparent sheet 20. The velocity may be determined by other factors such as a geometry of the 3D article 22 or the lower face 24. (D) Operate the movement mechanism 8 to position the lower face 24 in relation to the transparent sheet 20 and to move the lower face 24 with a specified velocity that can be partly based upon results from (C). (E) Receive a signal from sensor 12 and to determine the deflected vertical distance dZ. As the transparent sheet 20 deflects upward, dZ increases to a temporal maximum FZ. The controller also determines a magnitude of FZ. The controller also determines the time at which dZ reaches FZ during an upward motion of the build tray 6. (F) Operate the movement mechanism 8 to halt vertical motion of the build tray. This can be in response to determining that dZ equals FZ (during an upward motion) or in response to having moved downward by a magnitude of FZ (during a downward motion). (G) Operate the light engine 10 to image a layer of the photocurable resin 18 and to selectively harden a layer of cured resin onto the lower face 24. The controller 16 can be a single device or it can be a wired and/or networked arrangement of controllers. In addition, controller 16 may include portions that are internal to the light engine 10 and/or the movement mechanism 8.

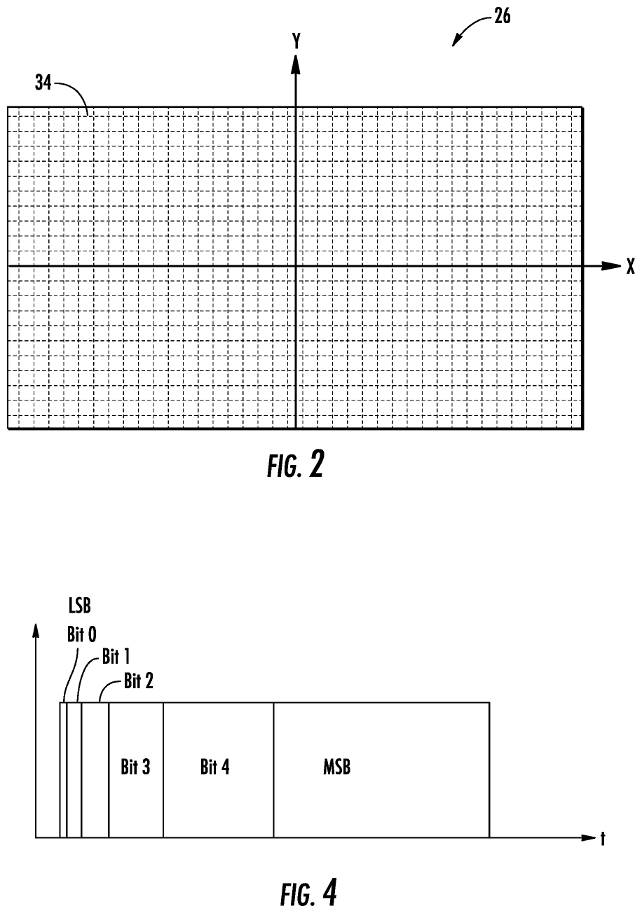

FIG. 2 is a schematic diagram representing the build plane 26. The build plane 26 represents a parallelepiped having a very thin Z axis and extending over the effective range of the light engine 10 in X and Y. The build plane 26 contains an array of pixels 34. When the build plane 26 is imaged by light engine 10, the pixels 34 individually receive a selected amount of light which is defined by an image frame.

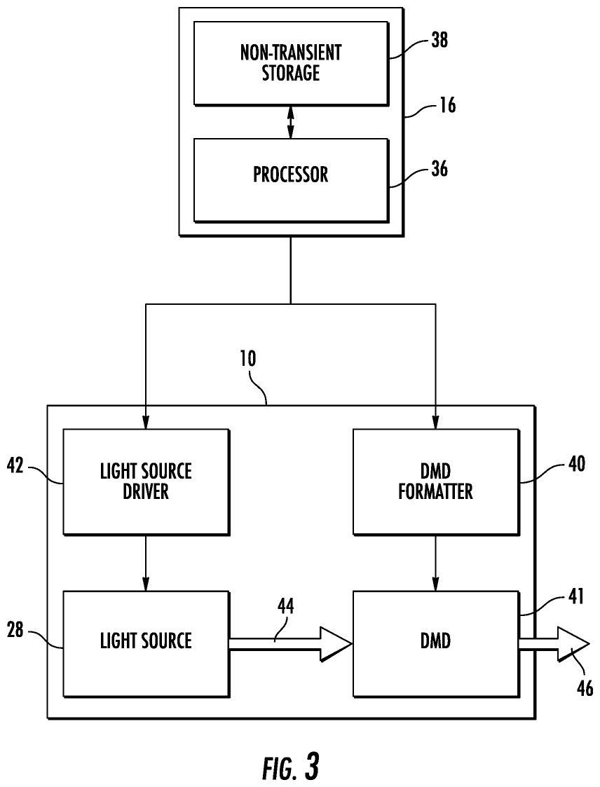

FIG. 3 is a simplified block diagram depicting an illustrative embodiment of a light engine 10 coupled to a controller 16. The controller 16 includes a processor 36 coupled to a non-transient storage device 38. In addition to storing the aforementioned software instructions, the non-transient storage device 38 receives and stores data defining the photocurable resin 18 and the 3D article 22 to be manufactured. The data defining the photocurable resin 18 can include the aforementioned material properties of cured resin. The data defining the 3D article includes a “stack” of image frames that individually define a pixelated image frame for a value of LZ. The stack of image frames define the 3D article 22 to be manufactured on a slice-by-slice basis with one image frame corresponding to one slice.

In the illustrated embodiment, the light engine 10 includes a digital mirror device (DMD) formatter 40 coupled to a digital mirror device (DMD) 41. The DMD 41 includes an array of at least 1 million switchable mirrors that are rapidly and individually switchable between an OFF state (light not sent to a build plane pixel) to an ON state (light sent to a build plane pixel). The individual mirrors typically correspond with the pixels 34 in a one-to-one correspondence (unless the system has pixel displacement optics). Thus when a given mirror is ON, it is illuminating a unique pixel 34 if the light source 28 is ON.

During operation, the processor 36 sends an image frame to the DMD formatter 40. The DMD formatter 40 converts the image frame to an image frame compatible with the DMD 41 that includes a series of bit planes for each of the switchable mirrors. FIG. 4 illustrates a sequence of bit planes for a single mirror. The bit planes are time slices having a binary determined duration. If the least significant bit (LSB) 0 is of time width t, then bit 2 has time width 2t, bit 3 has time width 4t, and so on up to the most significant bit (MSB). In an 8 bit system, the MSB would have 128 times the duration of the LSB. The mirrors toggle to define a pulse width modulated intensity for each pixel 34 pursuant to the received image frame. For example, an eight bit binary number 10000001 would result in the MSB and LSB bit planes being ON with the remaining bit planes being OFF. Toggling the bit planes ON and OFF allows 256 levels of illumination for an eight bit system. In some systems there are fewer or more bit planes, and so this is an illustrative example.

In the illustrated embodiment, the processor 36 is configured to receive an encoder signal from the movement mechanism 8. The processor 36 determines a value of LZ from the encoder signal and then loads the image frame into the DMD formatter 40 for that value of LZ. The DMD formatter 40 then repeatedly sends the formatted frame to the DMD 41 to provide a spatially modulated intensity across the build plane 26.

The light engine 10 also includes light source driver 42. The processor 36 activates or deactivates the light source 28 by sending a switching signal to the light source driver 42. Raw radiation 44 is emitted by the light source 28 which is then modulated to provide spatially modulated light 46 from the DMD 41.

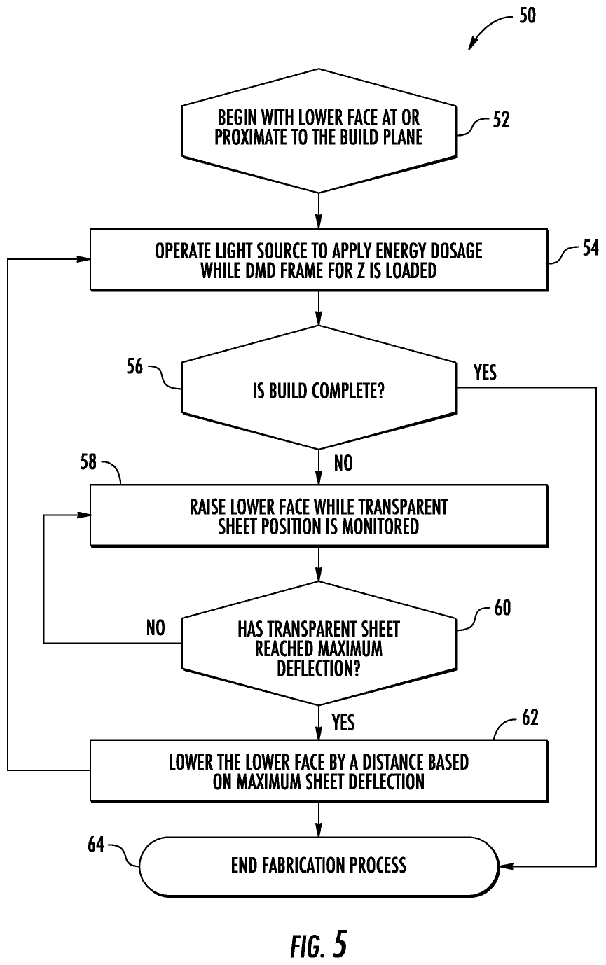

FIG. 5 is a flowchart depicting a method 50 of manufacturing 3D article 22. The controller 16 is configured to perform the method 50. According to 52, the lower face 24 of the build tray 6 or 3D article 22 is positioned at the build plane 26.

According to 54, the light engine 10 is operated to selectively harden a layer of cured resin onto the lower face 24. In an illustrative embodiment, step 54 is performed in the following manner: (a) The controller 16 receives an encoder signal from the movement mechanism 8 indicative of a Z-position (LZ) of the build tray 6. (b) The controller 16 loads an image frame corresponding to the Z-position (LZ). (c) The controller 16 sends the image frame to the DMD formatter 40. (d) The DMD formatter 40 begins sending formatted image frames to the DMD 41. (e) The controller 16 sends an ON signal to the light source driver 42 to activate the light source 28. After a predetermined imaging or cure time, the controller 16 sends an OFF signal to the light source driver 42 to deactivate the light source 28.

According to 56, a determination is made as to whether fabrication of the 3D article 22 is complete. If not, then the method 50 proceeds to step 58.

According to 58, the movement mechanism 8 is operated to raise the lower face 24 at a specified velocity. (The controller determined the specified velocity as discussed supra.) Also as part of 58, the controller 16 monitors a signal from the sensor 12 to determine the deflected vertical distance dZ of the transparent sheet 20.

According to 60, a determination is made as to whether the transparent sheet 20 deflection dZ has reached the temporal maximum deflection FZ. If it has not, then step 58 continues. If dZ has reached FZ, then motion of the build tray is immediately halted and a magnitude of the maximum deflection FZ is determined. The process then proceeds to 62.

According to 62, the build tray 6 is moved downward by a vertical distance equal to FZ. Then, the process loops back to step 54. Between the downward motion of step 62 and step 54 there is no need for a substantial settling time. Therefore step 54 can proceed in less than 500 milliseconds or less than 200 milliseconds or essentially immediately after step 62. Once according to step 56, the build is complete, the process moves to step 64.

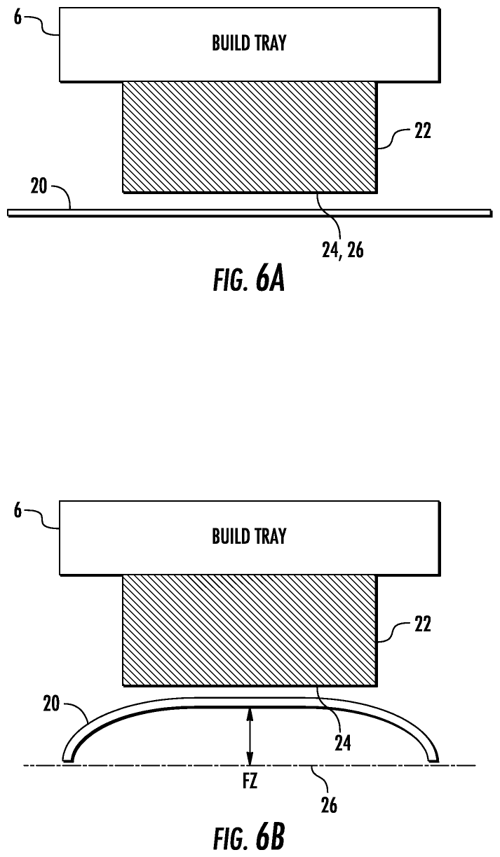

FIGS. 6A and 6B are simplified cross-sectional views of the build tray 6, 3D article 22, and the transparent sheet 20. In FIG. 6A, the lower face 24 is positioned at the build plane 26. In this physical configuration, step 54 of method 50 can take place.

During step 58, the lower face 24 is raised, and the transparent sheet 20 rises and deflects vertically along with the lower face 24 due to viscous drag on the transparent sheet 20. But as the lower face 24 is raised, elastic stretching of the transparent sheet 20 resists the upward deflection dZ. At a critical threshold of dZ equal to FZ, the viscous drag force balances the elastic force. During step 60, the controller is monitoring both LZ and dZ and can determine when dZ stops increasing (when dZ equals FZ). As part of step 60, the controller halts the upward movement and then immediately proceeds to step 62. Because this sequence does not increase a gap between the lower face 24 and the transparent sheet 20, the downward motion during step 62 simply maintains the gap. As a result, there is no need for a substantial settling time between the end of step 62 and a repeat of step 54.

The specific embodiments and applications thereof described above are for illustrative purposes only and do not preclude modifications and variations encompassed by the scope of the following claims.

What is claimed:

1. A three-dimensional (3D) printing system comprising:
a resin vessel configured to contain photocurable resin and including a transparent sheet, the transparent sheet having an upper surface defining a lower bound for the photocurable resin;
a build tray to support a 3D article, the build tray or the 3D article defining a lower face;
a movement mechanism coupled to the build tray;
a sensor configured to output a signal indicative of a vertical position of the transparent sheet;
a light engine configured to image a build plane that is proximate the upper surface of the transparent sheet;
a controller configured to:
(a) operate the movement mechanism to position the lower face at the build plane;
(b) operate the light engine to selectively harden a layer of the photocurable resin onto the lower face;
(c) operate the movement mechanism to begin raising the lower face at a specified velocity;
(d) concurrent with (c), receive the signal to monitor the vertical position of the transparent sheet;
(e) determine when the transparent sheet has reached a maximum upward vertical deflection;
(f) determine a magnitude of the maximum upward vertical deflection;
(g) based upon reaching the maximum deflection, lower the lower face by a vertical distance based upon a magnitude of the maximum upward vertical deflection;
(h) repeat step (b); and
(i) continue monitoring the signal and operating the movement mechanism and light engine to complete fabrication of the 3D article.

2. The three-dimensional (3D) printing system of claim 1 wherein the controller is further configured to determine the specified velocity based at least in part upon a mechanical property of a cured state of the photocurable resin, the mechanical property is based upon one or more of an elastic modulus and a yield strength.

3. The three-dimensional (3D) printing system of claim 2 wherein the controller is further configured to receive a signal indicative of a viscous force being exerted by the lower face upon the transparent sheet, the specified velocity is based at least in part upon the viscous force.

4. The three-dimensional (3D) printing system of claim 1 wherein between steps (c) and (g) the controller is configured to operate the movement mechanism to halt vertical motion when the transparent sheet has reached a maximum upward deflection.

5. The three-dimensional (3D) printing system of claim 1 wherein the light engine is activated in step (h) in less than 500 milliseconds after vertical motion of step (g) has stopped.

6. The three-dimensional (3D) printing system of claim 1 wherein the light engine is activated in step (h) in less than 200 milliseconds after vertical motion of step (g) has stopped.

7. The three-dimensional (3D) printing system of claim 1 wherein the light engine includes a light source and a spatial light modulator, a vertical position of the build tray is specified by an encoded coordinate LZ and the controller is further configured to:
store a plurality of data frames individually and uniquely correlated with a single value of LZ;
read LZ when the lower face is positioned at the build plane; and
load a data frame associated with LZ into the spatial light modulator.

8. A method of manufacturing a three-dimensional (3D) article comprising:
providing a three-dimensional (3D) printing system including:
a resin vessel configured to contain photocurable resin and including a transparent sheet, the transparent sheet having an upper surface defining a lower bound for the photocurable resin;
a build tray to support a 3D article, the build tray or the 3D article defining a lower face;
a movement mechanism coupled to the build tray;
a sensor configured to output a signal indicative of a vertical position of the transparent sheet; and
a light engine configured to image a build plane that is proximate the upper surface of the transparent sheet;
operating the movement mechanism to position the lower face at the build plane;
operating the light engine to selectively harden a layer of the photocurable resin onto the lower face;
operating the movement mechanism to begin raising the lower face at a specified velocity;
concurrent with operating the movement mechanism, receiving the signal to monitor the vertical position of the transparent sheet;
concurrent with receiving the signal, determining when the transparent sheet has reached a maximum upward vertical deflection;
determining a magnitude of the maximum upward vertical deflection;
lower the lower face by a vertical distance based upon a magnitude of the maximum upward vertical deflection;
operate the light engine to selectively harden a layer of the photocurable resin onto the lower face; and
repeat operating the movement mechanism and light engine until the 3D article fabrication is completed.

9. The method of claim 8 further including determining the specified velocity based at least in part upon a mechanical property of a cured state of the photocurable resin, the mechanical property is based upon one or more of an elastic modulus and a yield strength.

10. The method of claim 9 further including receiving a signal indicative of a viscous force being exerted by the lower face upon the transparent sheet, the specified velocity is based at least in part upon the viscous force.

11. The method of claim 8 further including operating the movement mechanism to halt vertical motion when the transparent sheet has reached a maximum upward deflection.

12. The method of claim 8 wherein the light engine is activated in less than 500 milliseconds after lowering the lower face by a vertical distance based upon a magnitude of the maximum upward vertical deflection.

13. The method of claim 8 wherein the light engine is activated in less than 200 milliseconds after lowering the lower face by a vertical distance based upon a magnitude of the maximum upward vertical deflection.

14. The method of claim 8 wherein the light engine includes a light source and a spatial light modulator, a vertical position of the build tray is specified by an encoded coordinate LZ and further including:
storing a plurality of data frames individually and uniquely correlated with a single value of LZ;
reading LZ when the lower face is positioned at the build plane; and
loading a data frame associated with LZ into the spatial light modulator.

15. A non-volatile storage media for a three dimensional (3D) printing system, the 3 D printing system including:
a resin vessel configured to contain photocurable resin and including a transparent sheet, the transparent sheet having an upper surface defining a lower bound for the photocurable resin;
a build tray to support a 3D article, the build tray or the 3D article defining a lower face;
a movement mechanism coupled to the build tray;
a sensor configured to output a signal indicative of a vertical position of the transparent sheet; and
a light engine configured to image a build plane that is proximate the upper surface of the transparent sheet;
the non-volatile storage medium storing software instructions that when executed cause a controller to:
(a) operate the movement mechanism to position the lower face at the build plane;
(b) operate the light engine to selectively harden a layer of the photocurable resin onto the lower face;
(c) operate the movement mechanism to begin raising the lower face at a specified velocity;
(d) concurrent with (c), receive the signal to monitor the vertical position of the transparent sheet;
(e) determine when the transparent sheet has reached a maximum upward vertical deflection;
(f) determine a magnitude of the maximum upward vertical deflection;
(g) based upon reaching the maximum deflection, lower the lower face by a vertical distance based upon a magnitude of the maximum upward vertical deflection;
(h) repeat step (b); and
(i) continue repetition of steps among steps (b) to (h) until the 3D article fabrication is completed.

16. The non-volatile storage media of claim 15, wherein the controller is further configured to determine the specified velocity based at least in part upon a mechanical property of a cured state of the photocurable resin, the mechanical property is based upon one or more of an elastic modulus and a yield strength.

17. The non-volatile storage media of claim 16, wherein the controller is further configured to receive a signal indicative of a viscous force being exerted by the lower face upon the transparent sheet, the specified velocity is based at least in part upon the viscous force.

18. The non-volatile storage media of claim 15, wherein between steps (c) and (g) the controller is configured to operate the movement mechanism to halt vertical motion when the transparent sheet has reached a maximum upward deflection.

19. The non-volatile storage media of claim 15, wherein the light engine is activated in step (h) in less than 500 milliseconds after vertical motion of step (g) has stopped.

20. The non-volatile storage media of claim 15, wherein the light engine includes a light source and a spatial light modulator, a vertical position of the build tray is specified by an encoded coordinate LZ and the controller is further configured to:
store a plurality of data frames individually and uniquely correlated with a single value of LZ;
read LZ when the lower face is positioned at the build plane; and
load a data frame associated with LZ into the spatial light modulator.
